(19) United States
(12) Patent Application Publication
(10) Pub. No.: US 2025/0342660 A1
(43) Pub. Date: Nov. 6, 2025

(54) INFORMATION PROCESSING DEVICE, INFORMATION PROCESSING METHOD, AND COMPUTER PROGRAM PRODUCT

(71) Applicant: Socionext Inc., Kanagawa (JP)

(72) Inventors: Yasuhiro OUCHI, Yokohama (JP); Kazuyuki OHHASHI, Yokohama (JP)

(21) Appl. No.: 19/264,345

(22) Filed: Jul. 9, 2025

Related U.S. Application Data
(63) Continuation of application No. PCT/JP2023/002162, filed on Jan. 24, 2023.

(51) Int. Cl. G06T 17/05; G06T 7/579; G06T 7/73

(52) U.S. Cl. CPC G06T 17/05; G06T 7/579; G06T 7/74; G06T 2200/08; G06T 2207/20212; G06T 2207/30252

(57) ABSTRACT

According to one aspect, an information processing device includes a VSLAM processing unit serving as a map information generation unit, and a self-location updating unit serving as a self-location generation unit. The VSLAM processing unit selectively performs generation processing according to a first mode for generation of map information including position information of an object around a mobile body with a first frequency and generation of first self-location information indicating a self-location of the mobile body, and generation processing according to a second mode for generation of the map information with a second frequency lower than the first frequency. In the generation processing according to the second mode of the map information generating unit, the self-location updating unit (301) uses the first self-location information and a state information of the mobile body to generate second self-location information being position information of the mobile body in the map information.

### CROSS-REFERENCE TO RELATED APPLICATIONS

This application is a continuation of International Application No. PCT/JP2023/002162, filed on Jan. 24, 2023, the entire contents of which are incorporated herein by reference.

### FIELD

The present invention relates to an information processing device, an information processing method, and a computer program product.

### BACKGROUND

There is a technology to acquire information about positions around a mobile body by using simultaneous localization and mapping (SLAM), sensor ranging, or the like and generate an environmental map or estimate self-location. In addition, there is an odometry method to calculate a movement amount of a mobile body by using information such as a tire rotation rate or steering wheel angle of the mobile body. Furthermore, there are a technology to generate an overhead view image showing around a mobile body by using images from a plurality of cameras mounted on the mobile body such as a vehicle, and a technology to change the shape of a projection plane for the overhead view image according to a three-dimensional object around the mobile body.

Patent Literature 1: JP 2009-205226 A

Patent Document 2: JP 2020 021257 A

Patent Literature 3: JP 2020 076877 A

Patent Literature 4: WO 2021/111531 A

The generation of the environment map or the estimation of the self-location has a large processing load. Therefore, the generation of the overhead view image showing around the mobile body or the like may provide an unnatural image.

### BRIEF DESCRIPTION OF THE DRAWINGS

FIG. 1 is a diagram illustrating an exemplary overall configuration of an information processing system according to an embodiment;

FIG. 2 is a diagram illustrating an exemplary hardware configuration of an information processing device according to an embodiment;

FIG. 3 is a diagram illustrating an exemplary functional configuration of an information processing device according to an embodiment;

FIG. 4 is a schematic diagram illustrating an example of environmental map information according to an embodiment;

FIG. 5 is a schematic diagram illustrating an exemplary functional configuration of a determination unit;

FIG. 6 is a schematic diagram illustrating an example of a reference projection plane;

FIG. 7 is an explanatory diagram of an asymptotic curve Q generated by the determination unit;

FIG. 8 is a schematic diagram illustrating an example of a projection geometry determined by the determination unit;

FIG. 9 is a diagram illustrating an overhead view image stabilization process;

FIG. 10 is a diagram illustrating the overhead view image stabilization process in a section in which a mobile body moves forward in a state illustrated in FIG. 9;

FIG. 11 is a diagram illustrating the overhead view image stabilization process in the section in which the mobile body moves forward in the state illustrated in FIG. 9;

FIG. 12 is a diagram illustrating the overhead view image stabilization process in the section in which the mobile body moves forward in the state illustrated in FIG. 9;

FIG. 13 is a diagram illustrating the overhead view image stabilization process for the mobile body stopped and followed by changing gears from drive to reverse in the state illustrated in FIG. 9;

FIG. 14 is a diagram illustrating switching timing from generation processing according to a first mode to generation processing according to a second mode in the overhead view image stabilization process in the state illustrated in FIG. 9;

FIG. 15 is a flowchart illustrating an example of the overhead view image stabilization process according to an embodiment;

FIG. 16 is a flowchart illustrating an example of an environmental map information generation process according to the first mode before transition to the second mode;

FIG. 17 is a flowchart illustrating an example of the overhead view image generation process after transition from the first mode to the second mode;

FIG. 18 is a diagram illustrating control of the frequency of an environmental map information generation process in an overhead view image stabilization process according to a second embodiment;

FIG. 19 is a diagram illustrating control of the frequency of the environmental map information generation process in the overhead view image stabilization process according to the second embodiment;

FIG. 20 is a diagram illustrating control of the frequency of the environmental map information generation process in the overhead view image stabilization process according to the second embodiment; and

FIG. 21 is a diagram illustrating switching timing from generation processing according to a second mode to generation processing according to a first mode in the overhead view image stabilization process in the states illustrated in FIGS. 18, 19, and 20.

### DETAILED DESCRIPTION

Hereinafter, embodiments of an information processing device, an information processing method, and a computer program product that are disclosed in the present application will be described in detail with reference to the accompanying drawings. Note that the following embodiments do not limit the disclosed technology. The embodiments are allowed to be appropriately combined to the extent that there is no contradiction with the processing contents.

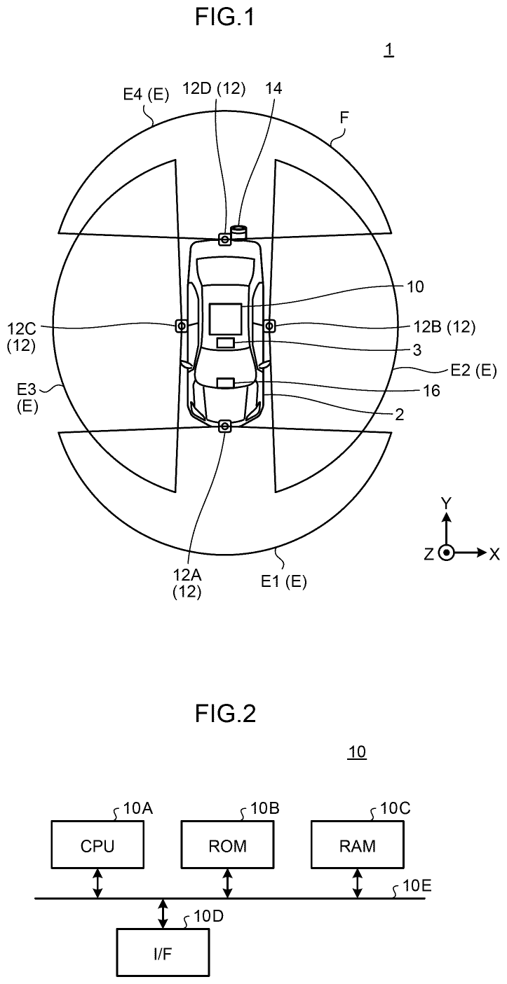

FIG. 1 is a diagram illustrating an exemplary overall configuration of an information processing system 1 according to the present embodiment. The information processing system 1 includes an information processing device 10, image capture units 12, a detection unit 14, and a display unit 16. The information processing device 10, the image capture units 12, the detection unit 14, and the display unit 16 are connected so as to exchange data or signals.

In the present embodiment, an exemplary form will be described in which the information processing device 10, the image capture units 12, the detection unit 14, and the display unit 16 are mounted on a mobile body 2.

The mobile body 2 is a movable object. Examples of the mobile body 2 include a vehicle, a flying object (manned airplane, unmanned airplane (e.g., an unmanned aerial vehicle (UAV) or a drone)), a robot, and the like. In addition, the mobile body 2 is, for example, a mobile body that travels through driving operation by a person or a mobile body that is configured to automatically travel (autonomously travel) without driving operation by a person. In the present embodiment, an example of the mobile body 2 as a vehicle will be described. Examples of the vehicle include, for example, a two-wheeled vehicle, a three-wheeled vehicle, and a four-wheeled vehicle. In the present embodiment, an example of the vehicle that is a four-wheeled vehicle configured to be autonomously driven will be described.

Note that the information processing device 10, the image capture units 12, the detection unit 14, and the display unit 16 may have a form not limited to the form in which all of the information processing device 10, the image capture units 12, the detection unit 14, and the display unit 16 are mounted on the mobile body 2. The information processing device 10 may be mounted on, for example, a stationary object. The stationary object is an object fixed to the ground. The stationary object is an immovable object or an object being stationary with respect to the ground. The stationary object is, for example, a traffic light, a parked vehicle, a road sign, or the like. Furthermore, the information processing device 10 may be mounted on a cloud server that performs processing in the cloud.

Each of the image capture units 12 captures an image around the mobile body 2 and acquires captured image data. Hereinafter, the captured image data will be simply referred to as a captured image. In the present embodiment, a description will be given on the assumption that each image capture unit 12 is, for example, a digital camera configured to capture a moving image, for example, a monocular fisheye camera having a viewing angle of approximately 195 degrees. Note that image capturing refers to converting an image of a subject formed by an optical system such as a lens into an electric signal. The image capture unit 12 outputs the captured image to the information processing device 10.

In the present embodiment, an exemplary form will be described in which four image capture units 12 of a front image capture unit 12A, a left image capture unit 12B, a right image capture unit 12C, and a rear image capture unit 12D are mounted on the mobile body 2. A plurality of the image capture units 12 (front image capture unit 12A, left image capture unit 12B, right image capture unit 12C, and rear image capture unit 12D) capture images of subjects in image capture areas E (front image capture area E1, left image capture area E2, right image capture area E3, and rear image capture area E4) in different directions to acquire captured images. In other words, it is assumed that the plurality of the image capture units 12 have different image capturing directions. In addition, it is assumed that the image capturing directions of the plurality of the image capture units 12 are adjusted in advance so that the image capture areas E overlaps at least partially between the adjacent image capture units 12. Furthermore, in FIG. 1, each of the image capture areas E is illustrated in a size as illustrated in FIG. 1 for convenience of description, but actually includes an area extending further away from the mobile body 2.

Furthermore, the four image capture units of the front image capture units 12A, the left image capture unit 12B, the right image capture unit 12C, and the rear image capture unit 12D are merely an example, and the number of the image capture units 12 is not limited. For example, in a case where the mobile body 2 has a vertically long shape, such as a bus or a truck, the image capture units 12 can be arranged on a front side, a rear side, a front side of a right side surface, a rear side of the right side surface, a front side of a left side surface, and a rear side of the left side surface of the mobile body 2, one by one, also using a total of six image capture units 12. In other words, the number and arrangement positions of the image capture units 12 can be appropriately set according to the size and shape of the mobile body 2.

The detection unit 14 detects position information of each of a plurality of detection points around the mobile body 2. In other words, the detection unit 14 detects the position information of each of the detection points in a detection area F. Each of the detection points represents each of points individually observed by the detection unit 14 in a real space. The detection points correspond to, for example, a three-dimensional object around the mobile body 2. Note that the detection unit 14 is an example of an external sensor.

The detection unit 14 is, for example, a three-dimensional (3D) scanner, a two dimensional (2D) scanner, a distance sensor (millimeter-wave radar and laser sensor), a sonar sensor to detect an object by sound waves, an ultrasonic sensor, or the like. The laser sensor is, for example, a three-dimensional laser imaging detection and ranging (LiDAR) sensor. Furthermore, the detection unit 14 may be a device using a technology of measuring a distance from an image captured by a stereo camera or a monocular camera, for example, a structure from motion (SfM) technology. Furthermore, the plurality of the image capture units 12 may be used as the detection unit 14. Furthermore, one of the plurality of the image capture units 12 may be used as the detection unit 14.

The display unit 16 displays various information. The display unit 16 is, for example, a liquid crystal display (LCD), an organic electro-luminescence (EL) display, or the like.

In the present embodiment, the information processing device 10 is communicably connected to an electronic control unit (ECU) 3 mounted on the mobile body 2. The ECU 3 is a unit that performs electronic control of the mobile body 2. In the present embodiment, it is assumed that the information processing device 10 is configured to receive controller area network (CAN) data such as a speed and a moving direction of the mobile body 2 from the ECU 3.

Next, a hardware configuration of the information processing device 10 will be described.

FIG. 2 is a diagram illustrating an exemplary hardware configuration of the information processing device 10.

The information processing device 10 includes a central processing unit (CPU) 10A, a read only memory (ROM) 10B, a random access memory (RAM) 10C, and an interface (I/F) 10D, and is, for example, a computer. The CPU 10A, the ROM 10B, the RAM 10C, and the I/F 10D are mutually connected by a bus 10E, and have a hardware configuration using a normal computer.

The CPU 10A is an arithmetic device that controls the information processing device 10. The CPU 10A corresponds to an example of a hardware processor. The ROM 10B stores programs and the like implementing various processes by the CPU 10A. The RAM 10C stores data necessary for various processes by the CPU 10A. The I/F 10D is an interface for connection to each image capture unit 12, the detection unit 14, the display unit 16, the ECU 3, and the like to transmit and receive data.

A program (computer program product) for information processing executed by the information processing device 10 of the present embodiment is provided by being incorporated in the ROM 10B or the like in advance. Note that the program executed by the information processing device 10 according to the present embodiment may be provided by being recorded on a recording medium, in the form of a file installable or executable on the information processing device 10. The recording medium is a computer-readable medium. The recording medium is a compact disc (CD)-ROM, a flexible disk (FD), a CD recordable (CD-R), a digital versatile disk (DVD), a universal serial bus (USB) memory, a secure digital (SD) card, or the like.

Next, a functional configuration of the information processing device 10 according to the present embodiment will be described. In the information processing device 10, surrounding position information about the mobile body 2 and self-location information of the mobile body 2 are simultaneously estimated from the captured images captured by the image capture units 12 by VSLAM processing. The information processing device 10 stitches a plurality of captured images spatially adjacent to generate a composite image (overhead view image) of the periphery of the mobile body 2 viewed from above, for display. Note that, in the present embodiment, at least one of the image capture units 12 is used as the detection unit 14, and the detection unit 14 performs processing of an image acquired from the image capture unit 12.

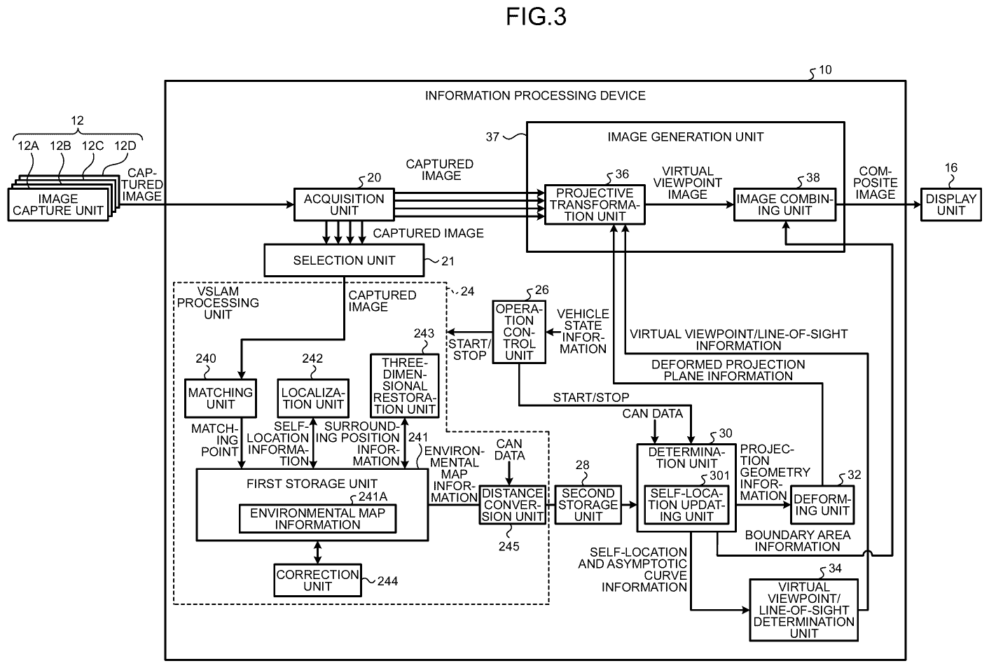

FIG. 3 is a diagram illustrating an exemplary functional configuration of the information processing device 10. Note that FIG. 3 also illustrates the image capture units 12 and the display unit 16 in addition to the information processing device 10, for clarity of a relationship between input and output of data.

The information processing device 10 includes an acquisition unit 20, a selection unit 21, an operation control unit 26, a VSLAM processing unit 24, a second storage unit 28, a determination unit 30, a deforming unit 32, a virtual viewpoint/line-of-sight determination unit 34, and an image generation unit 37.

Some or all of a plurality of the units may be implemented, for example, by causing a processing device such as the CPU 10A to execute a program, that is, by software. In addition, some or all of the plurality of the units may be implemented by hardware such as an integrated circuit (IC), or may be implemented by using software and hardware together.

The acquisition unit 20 acquires captured images from the image capture units 12. In other words, the acquisition unit 20 acquires a captured image from each of the front image capture unit 12A, the left image capture unit 12B, the right image capture unit 12C, and the rear image capture unit 12D.

Every time the captured image is acquired, the acquisition unit 20 outputs the acquired captured image to a projective transformation unit 36 and the selection unit 21.

The selection unit 21 selects a detection point detection area. In the present embodiment, the selection unit 21 selects a detection area by selecting at least one image capture unit 12 from among the plurality of the image capture units 12 (image capture units 12A to 12D).

The VSLAM processing unit 24 generates, on the basis of an image around the mobile body 2, first information including position information of a surrounding three-dimensional object around the mobile body 2 and position information of the mobile body 2. In other words, the VSLAM processing unit 24 receives a captured image from the selection unit 21, performs the VSLAM processing with the captured image to generate environmental map information, and outputs the generated environmental map information to a distance conversion unit 245.

In addition, in the VSLAM processing unit 24, an operation mode for generation of the environmental map information includes generation processing according to a first mode and generation processing according to a second mode. The generation processing according to the first mode is a mode of generating map information including position information of an object around the mobile body 2 with a first frequency, and generating the self-location information indicating a self-location of the mobile body 2 with a predetermined frequency. The generation processing according to the second mode is a mode of generating the map information with a second frequency lower than the first frequency. Here, the frequency means the number of times processing is performed per unit time.

Here, the self-location information of the mobile body 2 generated in the generation processing according to the first mode is referred to as first self-location information. The first self-location information is generated by VSLAM processing in the VSLAM processing unit 24. Furthermore, after the VSLAM processing unit 24 transitions to the generation processing according to the second mode, the self-location information of the mobile body 2 generated by a self-location updating unit 301 which is described later is referred to as second self-location information. The second self-location information is generated by odometry processing, for example. Note that the VSLAM processing unit 24 is an example of a map information generation unit.

More specifically, the VSLAM processing unit 24 includes a matching unit 240, a first storage unit 241, a localization unit 242, a three-dimensional restoration unit 243, and a correction unit 244.

The matching unit 240 performs, for a plurality of captured images having different image capture timings (a plurality of captured images having different frames), feature extraction processing, and matching processing between the respective images. Specifically, the matching unit 240 performs the feature extraction processing for the plurality of captured images. The matching unit 240 performs, for the plurality of captured images having different image capture timings, matching processing of identifying corresponding points between the plurality of captured images by using features between the plurality of captured images. The matching unit 240 outputs a result of the matching processing to the first storage unit 241.

The localization unit 242 uses a plurality of matching points acquired by the matching unit 240 to estimate, as the first self-location information, a self-location relative to each of the captured images, by projective transformation or the like. Here, the first self-location information includes information about the position (three-dimensional coordinates) and inclination (rotation) of the image capture unit 12. The localization unit 242 causes the first storage unit 241 to store environmental map information 241A including, as point cloud information, the first self-location information.

The three-dimensional restoration unit 243 uses a movement amount (translation amount and rotation amount) of the first self-location information estimated by the localization unit 242 to perform perspective projection transformation process, and determines the three-dimensional coordinates (coordinates relative to the self-location) of the matching points. The three-dimensional restoration unit 243 causes the first storage unit 2431 to store the environmental map information 241A including, as the point cloud information, the surrounding position information being the determined three-dimensional coordinates.

Therefore, new surrounding position information and new first self-location information are sequentially added to the environmental map information 241A with the movement of the mobile body 2 on which the image capture units 12 are mounted.

The first storage unit 241 stores various data such as the environmental map information 241A. The first storage unit 241 is, for example, a semiconductor memory element such as a RAM or a flash memory, a hard disk, an optical disk, or the like. Note that the first storage unit 241 may be a storage device provided outside the information processing device 10. Furthermore, the first storage unit 241 may be a storage medium. Specifically, the storage medium may be configured to store or temporarily store a program or various information downloaded via a local area network (LAN), the Internet, or the like.

The environmental map information 241A is information in which the point cloud information as the surrounding position information calculated by the three-dimensional restoration unit 243 and the point cloud information as the first self-location information calculated by the localization unit 242 are registered in a three-dimensional coordinate space with the origin (reference position) at a predetermined position in the real space. The predetermined position in the real space may be determined on the basis of, for example, a preset condition.

For example, the predetermined position used for the environmental map information 241A is the self-location of the mobile body 2 for the information processing of the present embodiment performed by the information processing device 10. For example, it is assumed that information processing is performed at predetermined timing such as a scene of parking the mobile body 2. In this configuration, the information processing device 10 preferably sets the self-location of the mobile body 2 when the predetermined timing is determined, as the predetermined position. For example, the information processing device 10 preferably determines the predetermined timing, when the behavior of the mobile body 2 has a behavior indicating the scene of parking. The behavior indicating a backward parking scene includes, for example, the speed of the mobile body 2 being equal to or less than a predetermined speed, the mobile body 2 put in back gear, reception of a signal indicating the start of parking by a user's operation instruction, or the like. Note that the predetermined timing is not limited to the scene of parking.

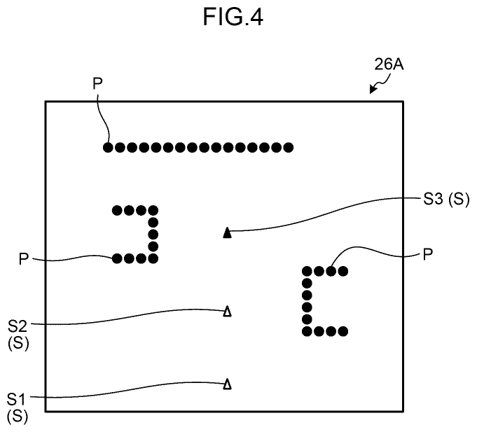

FIG. 4 is a schematic diagram 26A of an example of the environmental map information 241A with specific height information extracted. As illustrated in FIG. 4, the environmental map information 241A is information in which the point cloud information as position information (surrounding position information) of detection points P and the point cloud information as self-location information of a self-location S of the mobile body 2 are registered at corresponding coordinate positions in the three-dimensional coordinate space. Note that, in FIG. 4, the self-locations S of a self-location S1 to a self-location S3 are illustrated as an example. A larger numerical value following S means that the self-location S is closer to the current timing.

The correction unit 244 corrects the surrounding

position information and the self-location information which have been registered in the environmental map information 241A by using, for example, a least squares method or the like so that a sum of differences in distance in the three-dimensional space is minimized with respect to a point subjected to matching a plurality of times between a plurality of frames, between three-dimensional coordinates calculated in the past and three-dimensional coordinates newly calculated. Note that the correction unit 244 may correct a movement amount (translation amount and rotation amount) of the self-location used in the process of calculating the self-location information and the surrounding position information.

Timing for processing of the correction by the correction unit 244 is not limited. For example, the correction unit 244 preferably performs the processing of the correction described above at every predetermined timing. The predetermined timing may be determined on the basis of, for example, a preset condition. Note that, in the present embodiment, an example of the information processing device 10 including the correction unit 244 will be described. However, the information processing device 10 may not include the correction unit 244.

The distance conversion unit 245 converts a relative positional relationship between the self-location and the surrounding three-dimensional object, which can be known from the environmental map information, into an absolute value of a distance from the self-location to the surrounding three-dimensional object to generate detection point distance information about the surrounding three-dimensional object, and outputs the detection point distance information to the determination unit 30. Here, the detection point distance information is information about measured distance (coordinates) to each of a plurality of the detection points P, calculated by offsetting the self-location to coordinates (0, 0, 0), converted into, for example, meters. In other words, the information about the self-location of the mobile body 2 is included as coordinates (0, 0, 0) of the origin in the detection point distance information.

In distance conversion performed by the distance conversion unit 245, for example, state information such as speed data of the mobile body 2 included in CAN data sent from the ECU 3 is used. For example, in the environmental map information 241A illustrated in FIG. 4, the relative positional relationship between the self-location S and the plurality of the detection points P can be known, but the absolute value of the distance is not calculated. Here, an inter-frame period for which the self-location calculation is performed and the speed data during the inter-frame period indicated by the state information make it possible to obtain a distance between the self-location S3 and the self-location S2. The relative positional relationship included in the environmental map information 241A is similar to that in the real space, and therefore, the distance between the self-location S3 and the self-location S2 is known, also enabling obtaining the absolute values of the distances from the self-location S to all the other detection points P as well. In other words, the distance conversion unit 245 uses actual speed data of the mobile body 2 included in the CAN data to convert the relative positional relationship between the self-location and the surrounding three-dimensional object into the absolute value of the distance from the self-location to the surrounding three-dimensional object.

Note that the state information included in the CAN data and the environmental map information output from the VSLAM processing unit 24 is allowed to be associated with each other according to time information. In addition, when the detection unit 14 acquires the distance information about the detection points P, the distance conversion unit 245 may be removed.

When the VSLAM processing unit 24 performs the generation processing according to the first mode, the operation control unit 26 generates first trigger information on the basis of the state information of the mobile body 2. The operation control unit 26 outputs the generated first trigger information to the VSLAM processing unit 24 and the self-location updating unit 301 which is described later. Here, the state information is information including at least one of the speed data, gear information, the tire rotation rate, and the steering wheel angle of the mobile body 2, an instruction from the user, an overhead view image generation start trigger, and the like, which are included in the CAN data sent from the ECU 3. In addition, the first trigger information generated by the operation control unit 26 is information for transition of the operation of the VSLAM processing unit 24 from the generation processing according to the first mode to the generation processing according to the second mode, for reducing the frequency of the generation of the environmental map information according to the state information of the mobile body 2. Upon acquiring the first trigger information from the operation control unit 26, the VSLAM processing unit 24 causes the operation to transition from the generation processing according to the first mode to the generation processing according to the second mode.

The second storage unit 28 stores the environmental map information including the information about the self-location of the mobile body 2 sequentially output from the VSLAM processing unit 24, during the generation processing according to the first mode. Furthermore, the environmental map information stored in the second storage unit 28 is referred to by the self-location updating unit 301 of the determination unit 30, during the generation processing according to the second mode.

The determination unit 30 determines a shape of a projection plane on which an image acquired by each image capture unit 12 mounted on the mobile body 2 is projected and the overhead view image is generated.

Here, the projection plane is a three-dimensional plane for projection of a surrounding image around the mobile body 2 as the overhead view image. Furthermore, the surrounding image around the mobile body 2 is a captured image of surroundings around the mobile body 2, and is a captured image captured by each of the image capture unit 12A to the image capture unit 12D. The projection plane has a projection geometry that is a three-dimensional (3D) shape virtually formed in a virtual space corresponding to the real space. Furthermore, in the present embodiment, a determination of the projection geometry of the projection plane made by the determination unit 30 is referred to as projection geometry determination processing.

### Configuration Example of Determination Unit 30

Hereinafter, a detailed exemplary configuration of the determination unit 30 illustrated in FIG. 3 will be described.

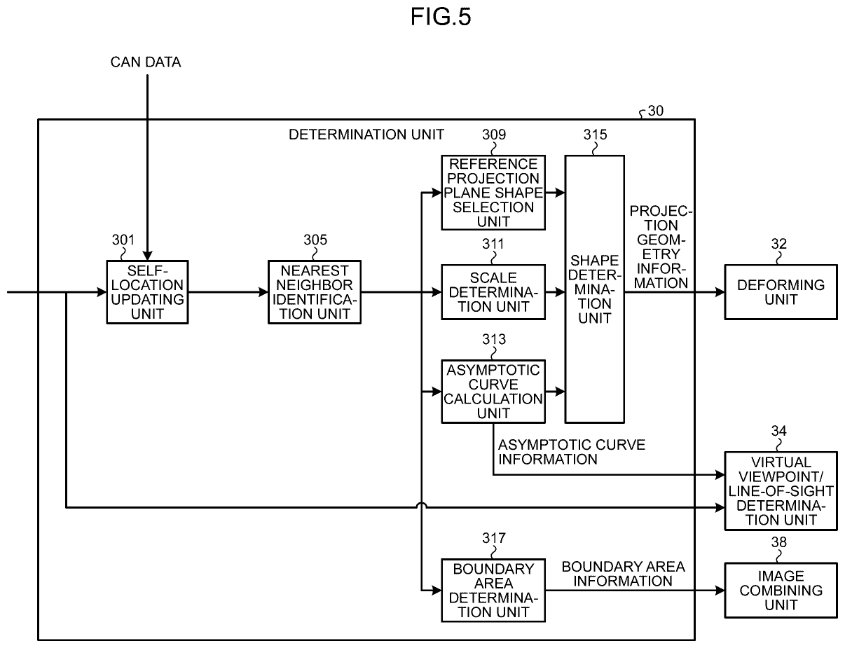

FIG. 5 is a schematic diagram illustrating an exemplary functional configuration of the determination unit 30. As illustrated in FIG. 5, the determination unit 30 includes the self-location updating unit 301, a nearest neighbor identification unit 305, a reference projection plane shape selection unit 309, a scale determination unit 311, an asymptotic curve calculation unit 313, a shape determination unit 315, and a boundary area determination unit 317.

The self-location updating unit 301 reads the environmental map information output from the VSLAM processing unit 24 and stored in the second storage unit 28, and outputs the environmental map information to the nearest neighbor identification unit 305 on a downstream side. In response to the first trigger information from the operation control unit 26 (i.e., in the second mode of the operation of the VSLAM processing unit 24), the self-location updating unit 301 reads the latest environmental map information stored in the second storage unit 28 to generate the second self-location information by odometry processing using the first self-location information and the state information that are included in the latest environmental map information. The generation of the second self-location information is performed at a predetermined rate (frequency).

The self-location updating unit 301 registers the generated second self-location information in the read environmental map information and outputs the environmental map information to the nearest neighbor identification unit 305. Note that the self-location updating unit 301 is an example of a self-location generation unit.

The nearest neighbor identification unit 305 uses a specific height extraction map to divide the surrounding of the self-location S of the mobile body 2 into specific ranges (i.e., angular ranges), identifies a detection point P closest to the mobile body 2 or a plurality of detection points P in order of proximity to the mobile body 2 for each range, and generates nearest neighbor information. Note that, in the present embodiment, an exemplary form will be described in which the nearest neighbor identification unit 305 identifies a plurality of detection points P in order of proximity to the mobile body 2 for each range and generates the nearest neighbor information. In addition, it is assumed that the nearest neighbor information is acquired as the positions of nearest neighbors, for example, at every 90 degrees in four directions of the front, left, right, and rear sides from the mobile body 2.

The nearest neighbor identification unit 305 outputs the measured distance of the detection point P identified for each range as the nearest neighbor information, to the reference projection plane shape selection unit 309, the scale determination unit 311, the asymptotic curve calculation unit 313, and the boundary area determination unit 317, which are on the downstream side.

The reference projection plane shape selection unit 309 selects a shape of a reference projection plane.

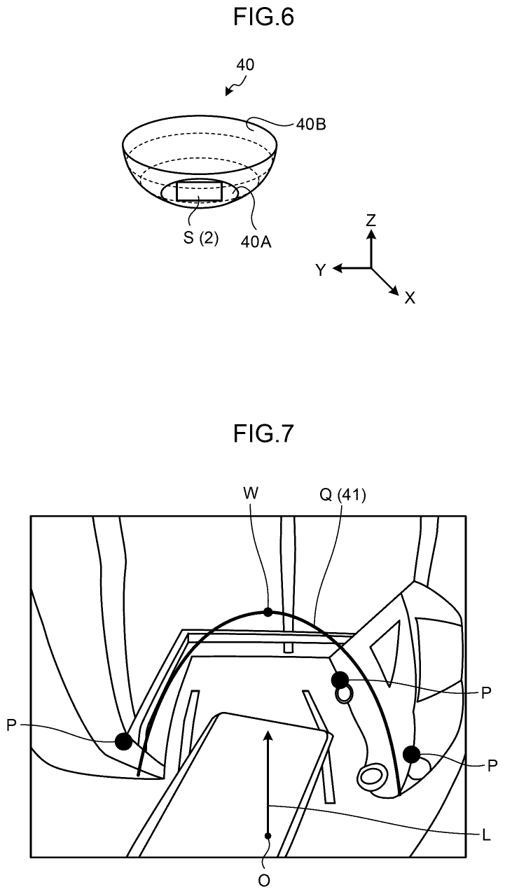

FIG. 6 is a schematic diagram illustrating an example of a reference projection plane 40. The reference projection plane will be described with reference to FIG. 6. The reference projection plane 40 is, for example, a projection plane having a shape serving as a reference upon changing the shape of the projection plane. The shape of the reference projection plane 40 is, for example, a bowl shape, a cylindrical shape, or the like. Note that FIG. 6 illustrates the reference projection plane 40 having the bowl shape.

The bowl shape is a shape having a bottom plane 40A and a side wall plane 40B, the side wall plane 40B having one end extending to the bottom plane 40A and the other end being opened. The side wall plane 40B has a horizontal cross-section increasing from the bottom plane 40A toward the opening of the other end portion in width. The bottom plane 40A has, for example, a circular shape. Here, the circular shape is a shape including a perfect circular shape and a circular shape other than the perfect circular shape such as an elliptical shape. The horizontal cross-section is an orthogonal plane perpendicular to the vertical direction (direction indicated by an arrow Z). The orthogonal plane is a two-dimensional plane extending in a direction indicated by an arrow X orthogonal to the direction indicated by the arrow Z and a direction indicated by an arrow Y orthogonal to the direction indicated by the arrow Z and the direction indicated by the arrow X. Hereinafter, the horizontal cross-section and the orthogonal plane are referred to as an XY plane in some case. Note that the bottom plane 40A may have a shape other than the circular shape, such as an egg shape.

The cylindrical shape is a shape that includes the bottom plane 40A having a circular shape and the side wall plane 40B extending to the bottom plane 40A. The side wall plane 40B constituting the reference projection plane 40 of cylindrical shape has a cylindrical shape in which an opening at one end extends to the bottom plane 40A and the other end portion is opened. However, the side wall plane 40B constituting the reference projection plane 40 of cylindrical shape has a shape in which the XY plane has a diameter substantially constant from the bottom plane 40A toward the opening at the other end. Note that the bottom plane 40A may have a shape other than the circular shape, such as an egg shape.

In the present embodiment, an example of the reference projection plane 40 having the bowl shape illustrated in FIG. 6 will be described. The reference projection plane 40 is a three-dimensional model virtually formed in the virtual space having the bottom plane 40A that is a plane substantially coinciding with a road surface below the mobile body 2, and the bottom plane 40A that has the center as the self-location S of the mobile body 2.

The reference projection plane shape selection unit 309 reads one specific shape from the plurality of types of reference projection planes 40 to select the shape of the reference projection plane 40. For example, the reference projection plane shape selection unit 309 selects the shape of the reference projection plane 40, according to the positional relationship, distance, and the like between the self-location and the surrounding three-dimensional object. Note that the shape of the reference projection plane 40 may be selected according to a user's operation instruction. The reference projection plane shape selection unit 309 outputs shape information about the determined shape of the reference projection plane 40, to the shape determination unit 315. In the present embodiment, as described above, an exemplary form will be described in which the reference projection plane shape selection unit 309 selects the reference projection plane 40 having the bowl shape.

The scale determination unit 311 determines the scale of the reference projection plane 40 having a shape selected by the reference projection plane shape selection unit 309. For example, when the distance from the self-location S to a nearest neighbor is shorter than a predetermined distance, the scale determination unit 311 determines to reduce the scale. The scale determination unit 311 outputs scale information about the determined scale to the shape determination unit 315.

The asymptotic curve calculation unit 313 calculates an asymptotic curve of the surrounding position information relative to the self-location, on the basis of the surrounding position information about the mobile body 2 and the self-location information thereof included in the environmental map information. The asymptotic curve calculation unit 313 outputs asymptotic curve information about an asymptotic curve Q calculated, to the shape determination unit 315 and the virtual viewpoint/line-of-sight determination unit 34, by using each of the distances of the detection points P closest to the self-location S for each range from the self-location S, received from the nearest neighbor identification unit 305.

FIG. 7 is an explanatory diagram of the asymptotic curve Q generated by the determination unit 30. Here, the asymptotic curve is an asymptotic curve derived from the plurality of the detection points P in the environmental map information. FIG. 7 illustrates an example in which the asymptotic curve Q is illustrated on a projection image obtained by projecting a captured image on a projection plane when the mobile body 2 is viewed from above. For example, it is assumed that the determination unit 30 identifies three detection points P in order of proximity to the self-location S of the mobile body 2. In this configuration, the determination unit 30 generates the asymptotic curve Q derived from these three detection points P.

Note that the asymptotic curve calculation unit 313 may obtain a representative point positioned at the center of gravity or the like of the plurality of the detection points P for each of the specific ranges (i.e., angular range) of the reference projection plane 40 to calculate the asymptotic curve Q to the representative points for a plurality of the ranges. Then, the asymptotic curve calculation unit 313 outputs the asymptotic curve information about the calculated asymptotic curve Q, to the shape determination unit 315. Note that the asymptotic curve calculation unit 313 may output the asymptotic curve information about the calculated asymptotic curve Q, to the virtual viewpoint/line-of-sight determination unit 34.

The shape determination unit 315 enlarges or reduces the reference projection plane 40 having a shape indicated by the shape information received from the reference projection plane shape selection unit 309, to the scale indicated by the scale information received from the scale determination unit 311. Then, the shape determination unit 315 determines, as the projection geometry, a shape obtained by deforming the enlarged or reduced reference projection plane 40 to have a shape according to the asymptotic curve information about the asymptotic curve Q received from the asymptotic curve calculation unit 313.

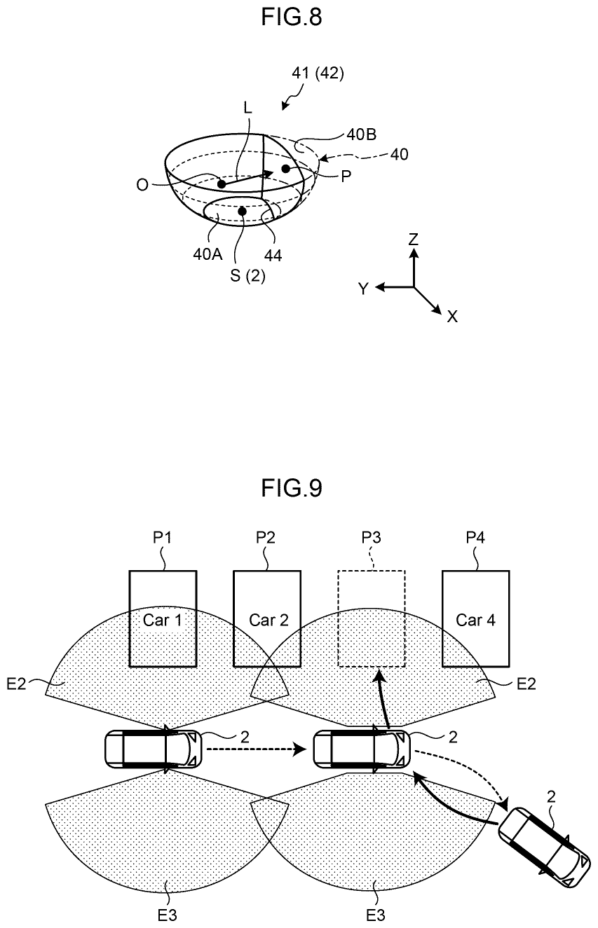

Here, the determination of the projection geometry will be described in detail. FIG. 8 is a schematic diagram illustrating an example of a projection geometry 41 determined by the determination unit 30. As illustrated in FIG. 8, the shape determination unit 315 determines, as the projection geometry 41, the shape of the reference projection plane 40 that has been deformed into a shape passing through a detection point P closest to the self-location S of the mobile body 2 which is at the center of the bottom plane 40A of the reference projection plane 40. The shape passing through the detection point P means that the side wall plane 40B after deformation has a shape passing through the detection point P. The self-location S is a self-location S calculated by the localization unit 242.

In other words, the shape determination unit 315 identifies the detection point P closest to the self-location S from among the plurality of the detection points P registered in the environmental map information. Specifically, the XY coordinates of the center position (self-location S) of the mobile body 2 is set as (X, Y)=(0,0). Then, the shape determination unit 315 identifies a detection point P that has a value of X²+Y² indicating a minimum value, as the detection point P closest to the self-location S. Then, the shape determination unit 315 determines, as the projection geometry 41, the shape of the side wall plane 40B of the reference projection plane 40 that has been deformed into a shape passing through the detection point P.

More specifically, the shape determination unit 315 determines, as the projection geometry 41, the shape of partial areas of the bottom plane 40A and the side wall plane 40B that have been changed so that the partial area of the side wall plane 40B is formed as a wall plane passing through the detection point P closest to the mobile body 2 upon changing the shape of the reference projection plane 40. The projection geometry 41 after deformation has, for example, a shape that rises from a rising line 44 on the bottom plane 40A, in a direction toward the center of the bottom plane 40A as viewed from a viewpoint on the XY plane (in plan view). The word rising means, for example, to bend or fold the side wall plane 40B and the bottom plane 40A partially in a direction toward the center of the bottom plane 40A so that an angle formed by the side wall plane 40B and the bottom plane 40A of the reference projection plane 40 is smaller. Note that in the rising shape, the rising line 44 may be positioned between the bottom plane 40A and the side wall plane 40B without deforming the bottom plane 40A.

The shape determination unit 315 determines to deform a specific area in the reference projection plane 40 so as to protrude at a position passing through the detection point P as viewed from a viewpoint on the XY plane (plan view). A shape and range of the specific area may be determined on the basis of a predetermined criterion. Then, the shape determination unit 315 determines so that the reference projection plane 40 has a shape in which the distance from the self-location S is continuously increased toward an area other than the specific area in the side wall plane 40B from the protruded specific area. Note that the shape determination unit 315 is an example of a projection geometry determination unit.

For example, as illustrated in FIG. 8, it is preferable to determine the projection geometry 41 so that an outer peripheral shape of a cross-section along the XY plane is a curved shape. Note that the outer peripheral shape of the cross-section of the projection geometry 41 is, for example, a circular shape, but may be a shape other than the circular shape.

Note that the shape determination unit 315 may determine, as the projection geometry 41, the shape of the reference projection plane 40 that has been changed into a shape extending along the asymptotic curve. The shape determination unit 315 generates an asymptotic curve derived from a predetermined number of the plurality of detection points P, in a direction away from the detection point P closest to the self-location S of the mobile body 2. A plurality of the detection points P is preferably provided. For example, the number of the detection points P is preferably three or more. Furthermore, in this case, the shape determination unit 315 preferably generates the asymptotic curve derived from the plurality of the detection points P at positions separated by a predetermined angle or more as viewed from the self-location S. For example, the shape determination unit 315 is allowed to determine, as the projection geometry 41, the shape of the reference projection plane 40 that has been changed into a shape extending along the generated asymptotic curve Q in the asymptotic curve Q illustrated in FIG. 7.

Note that the shape determination unit 315 may divide the surrounding of the self-location S of the mobile body 2 into specific ranges to identify the detection point P closest to the mobile body 2 or a plurality of the detection points P in order of proximity to the mobile body 2 for each range. Then, the shape determination unit 315 may determine, as the projection geometry 41, the shape of the reference projection plane 40 that has been changed into a shape passing through the detection points P identified for the respective ranges or into a shape extending along the asymptotic curve Q derived from the plurality of the identified detection points P.

Then, the shape determination unit 315 outputs projection geometry information about the determined projection geometry 41 to the deforming unit 32.

Referring back to FIG. 3, the deforming unit 32 deforms the projection plane on the basis of the projection geometry information received from the determination unit 30. The deformation of the reference projection plane is performed with, for example, the detection point P closest to the mobile body 2 as a reference. The deforming unit 32 outputs deformed projection plane information to the projective transformation unit 36.

Furthermore, for example, the deforming unit 32 deforms the reference projection plane into a shape extending along the asymptotic curve derived from a predetermined number of multiple detection points P in order of proximity to the mobile body 2 on the basis of the projection geometry information.

The virtual viewpoint/line-of-sight determination unit 34 determines virtual viewpoint/line-of-sight information on the basis of the self-location and the asymptotic curve information, and outputs the virtual viewpoint/line-of-sight information to the projective transformation unit 36.

The determination of the virtual viewpoint/line-of-sight information will be described with reference to FIGS. 7 and 8. For example, the virtual viewpoint/line-of-sight determination unit 34 determines, as a line-of-sight direction, a direction that passes through the detection point P closest to the self-location S of the mobile body 2 and is perpendicular to the deformed projection plane. Furthermore, for example, the virtual viewpoint/line-of-sight determination unit 34 fixes the orientation of the line-of-sight direction L, and determines the coordinates of a virtual viewpoint O as an appropriate Z coordinate and appropriate XY coordinates in a direction away from the asymptotic curve Q toward the self-location S. In this configuration, the XY coordinates may be coordinates at a position away from the asymptotic curve Q relative to the self-location S. Then, the virtual viewpoint/line-of-sight determination unit 34 outputs the virtual viewpoint/line-of-sight information indicating the virtual viewpoint O and the line-of-sight direction L, to the projective transformation unit 36. Note that, as illustrated in FIG. 8, the line-of-sight direction L may be a direction extending from the virtual viewpoint O toward the position of a vertex W of the asymptotic curve Q.

The image generation unit 37 generates the overhead view image showing around the mobile body 2 by using the projection plane. Specifically, the image generation unit 37 includes the projective transformation unit 36 and an image combining unit 38.

The projective transformation unit 36 generates the projection image obtained by projecting the captured image acquired from each image capture unit 12 on the deformed projection plane, on the basis of the deformed projection plane information and the virtual viewpoint/line-of-sight information. The projective transformation unit 36 converts the generated projection image into a virtual viewpoint image and outputs the virtual viewpoint image to the image combining unit 38. Here, the virtual viewpoint image is an image showing visual recognition of the projection image in any direction from the virtual viewpoint.

A projection image generation process by the projective transformation unit 36 will be described in detail with reference to FIG. 8. The projective transformation unit 36 projects the captured image onto a deformed projection plane 42. Then, the projective transformation unit 36 generates the virtual viewpoint image (not illustrated) that is an image showing visual recognition of the captured image projected onto the deformed projection plane 42 in the line-of-sight direction L from any virtual viewpoint O. The position of the virtual viewpoint O is preferably positioned, for example, at the self-location S of the mobile body 2 (as a reference in processing of deforming the projection plane). In this configuration, the values of the XY coordinates of the virtual viewpoint O is preferably set as the values of the XY coordinates of the self-location of the mobile body 2. Furthermore, the value of the Z coordinate (position in the vertical direction) of the virtual viewpoint O is preferably set as the value of the Z coordinate of the detection point P closest to the self-location of the mobile body 2. The line-of-sight direction L may be determined, for example, on the basis of a predetermined criterion.

The line-of-sight direction L is preferably, for example, a direction extending from the virtual viewpoint O toward the detection point P closest to the self-location S of the mobile body 2. Furthermore, the line-of-sight direction L may be a direction passing through the detection point P and perpendicular to the deformed projection plane 42. The virtual viewpoint/line-of-sight information indicating the virtual viewpoint O and the line-of-sight direction L is created by the virtual viewpoint/line-of-sight determination unit 34.

The image combining unit 38 generates the composite image having a part or all of the virtual viewpoint image extracted. For example, the image combining unit 38 performs stitching processing and the like for a plurality of the virtual viewpoint images (here, four virtual viewpoint images corresponding to the image capture units 12A to 12D) in boundary areas between the image capture units.

The image combining unit 38 outputs the generated composite image to the display unit 16. Note that the composite image may be an overhead view image with the virtual viewpoint O above the mobile body 2 or may display the mobile body 2 translucently with the virtual viewpoint O in the mobile body 2.

### Overhead View Image Stabilization Process

Next, an overhead view image stabilization process performed by the information processing device 10 according to the present embodiment will be described in detail. For example, when information processing requiring a large load, such as display of the overhead view image accompanied by deformation of the projection plane, is performed, if generation of the environmental map information with a large processing load is continuously performed with a normal frequency, there is a possibility of an unstable overhead view image, such as display of an unnatural overhead view image. The overhead view image stabilization process is to control the frequency of generation of the environmental map information according to a vehicle state of the mobile body 2 to reduce a load of information processing and stabilize the overhead view image generation.

Note that, in the present embodiment, for specific description, an example will be described in which the overhead view image stabilization process is started with acquisition of the state information indicating that gears are changed from drive to reverse in the mobile body 2 as a trigger. However, the present invention is not limited to this example, the start of the overhead view image stabilization process is not limited to this example, and, for example, acquisition of the state information including instruction information for the overhead view image stabilization process that is input from the user and overhead view image generation start information may be used as a trigger.

FIG. 9 is a diagram of an overhead view image stabilization process, and is a top view illustrating an example of a movement route of the mobile body 2 upon parking of the mobile body 2 in a parking area P3 and a surrounding state around the parking area P3. In the example illustrated in FIG. 9, on the left side of the mobile body 2 as viewed from the driver, Car 1 is parked in a parking area P1, Car 2 in a parking area P2, and Car 4 in a parking area P4, from the front side to the back side in a traveling direction. In addition, the parking area P3 between the parking area P2 and the parking area P4 has an empty space. The mobile body 2 travels while viewing the parking areas P1 to P4 on the left side, stops beyond the parking area P4 with a front side of the vehicle turned right, and then moves backward after the gears are changed from drive to reverse, and is parked in the parking area P3.

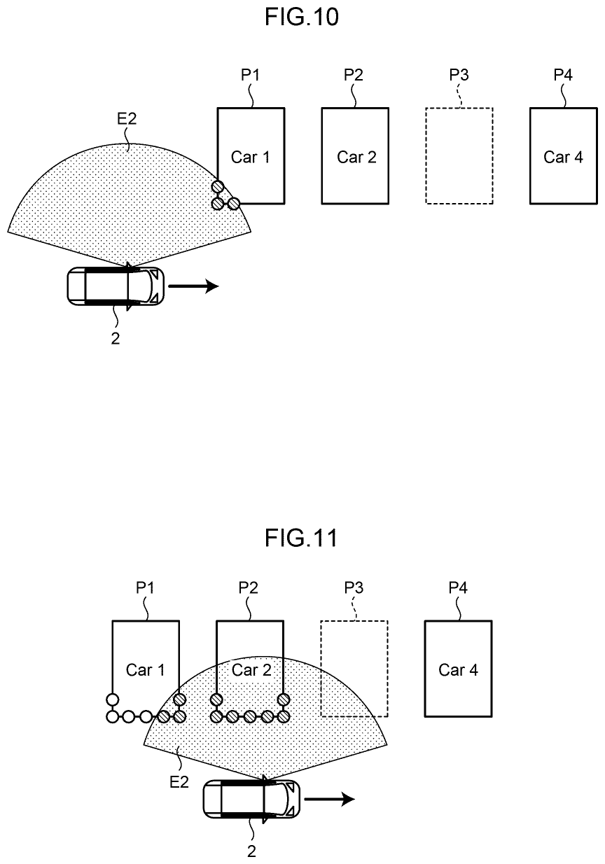

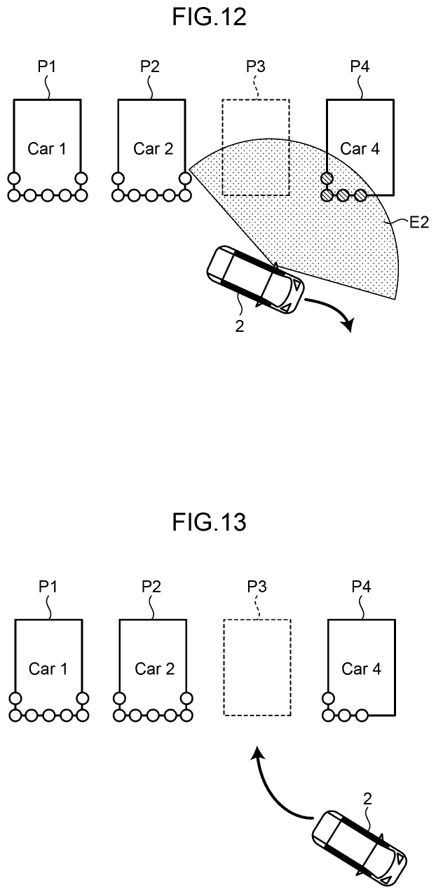

FIGS. 10, 11, and 12 are diagrams each illustrating the overhead view image stabilization process in a section in which the mobile body 2 moves forward in a state illustrated in FIG. 9. In sections illustrated in FIGS. 10, 11, and 12, when the mobile body 2 travels while viewing the parking areas P1 to P4 on the left side, until stopping beyond the parking area P4 with the front side of the vehicle turned right, the VSLAM processing unit 24 uses captured image and the like of the left image capture area E2 to execute generation of the environmental map information and localization in the generation processing according to the first mode. Therefore, in the sections illustrated in FIGS. 10, 11, and 12, the environmental map information including self-sustaining information is generated with the first frequency.

Note that circles illustrated at the boundaries of Cars in FIGS. 10, 11, and 12 indicate the detection points detected in the VSLAM processing. A hatched circle, among the circles, illustrates the detection point detected in the current VSLAM processing, and a white circle illustrates the detection point detected in the past VSLAM processing.

FIG. 13 is a diagram illustrating the overhead view image stabilization process for the mobile body 2 stopped and followed by changing the gears from drive to reverse in the state illustrated in FIG. 9. As illustrated in FIG. 13, after the mobile body 2 stops beyond the parking area P4 with the front side of the vehicle turned rightward, the gears are changed from drive to reverse in the mobile body 2. In such a case, the operation control unit 26 acquires the state information about the changing the gears in the mobile body 2, from the ECU 3, generates the first trigger information on the basis of the state information, and outputs the first trigger information to the VSLAM processing unit 24 and the self-location updating unit 301.

In response to the first trigger information acquired from the operation control unit 26, the VSLAM processing unit 24 causes processing of generating the environmental map information to transition from the first mode in which the processing is performed with the first frequency to the second mode in which the processing is performed with the second frequency lower than the first frequency. Thereafter, the VSLAM processing unit 24 performs the processing of generating the environmental map information according to the second mode. Note that, for the second frequency, any value lower than that of the first frequency is allowed to be set. In the present embodiment, for specific description, an example will be described in which a set value for the second frequency is set to “0”, and new environmental map information is not generated in the generation processing according to the second mode. Note that the set value is a numerical value that determines the number of times the processing is performed per unit time, and for example, setting “0” means that the environmental map information is generated 0 times per unit time, that is, the environmental map information is not generated.

In response to the first trigger information acquired from the operation control unit 26, the self-location updating unit 301 reads, for example, the latest environmental map information (including the first self-location information) from the second storage unit 28. Furthermore, the self-location updating unit 301 uses the state information acquired from the ECU 3 and the read environmental map information to start localization processing according to the odometry method. The self-location updating unit 301 registers the second self-location information generated by the localization processing, in the environmental map information. The self-location updating unit 301 outputs the environmental map information in which the second self-location information is registered, to the nearest neighbor identification unit 305 on the downstream side.

Thereafter, the second self-location information is sequentially updated by the self-location updating unit 301 without generating new environmental map information by the VSLAM processing unit 24. After the operation of the

VSLAM processing unit 24 transitions from the first mode to the second mode, the determination unit 30 uses the environmental map information generated according to the first mode and stored in the second storage unit 28 and the second self-location information updated in real time to perform the projection geometry determination processing. Similarly, after the operation of the VSLAM processing unit 24 transitions from the first mode to the second mode, the image generation unit 37 uses the projection plane shape determined by using the environmental map information generated according to the first mode and stored in the second storage unit 28 and the second self-location information updated in real time to generate the overhead view image.

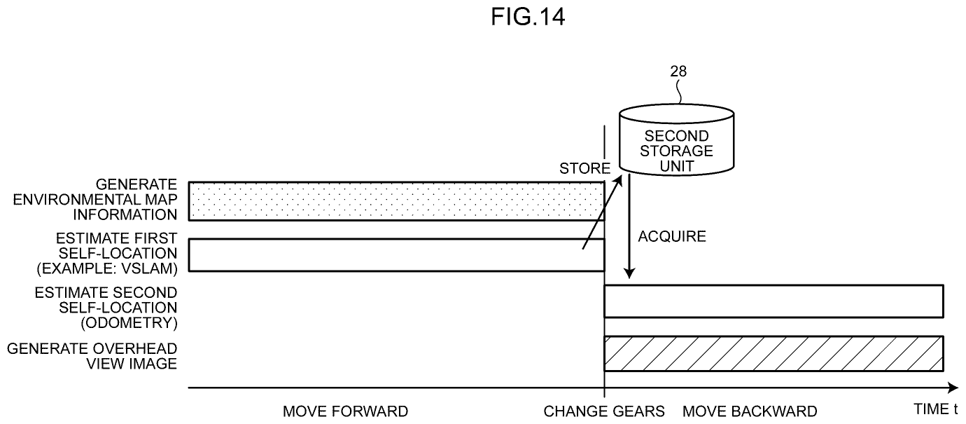

FIG. 14 is a diagram illustrating switching (i.e., switching of generation of the environmental map information and self-location information generation) timing from the generation processing according to the first mode to the generation processing according to the second mode, in the overhead view image stabilization process in the state illustrated in FIG. 9.

In other words, as illustrated in FIG. 14, while the mobile body 2 is moving forward, the environmental map information and the first self-location information are generated with the first frequency in the generation processing according to the first mode. The generated environmental map information and first self-location information are sequentially stored in the second storage unit 28. Then, the generation processing according to the first mode transitions to the generation processing according to the second mode, at the timing when the gears are changed from drive to reverse in the mobile body 2. After the gears are changed, the operation is performed on the basis of the environmental map information having already been generated in the generation processing according to the first mode, upon backward parking. Therefore, in the generation processing according to the second mode, the overhead view image is generated using the environmental map information having already been generated according to the generation processing according to the first mode and the second self-location information generated by the odometry method, without generating the environmental map information.

This configuration makes it possible to stop the generation of the environmental map generation information during the backward movement after the transition to the generation processing according to the second mode, and the processing load can be reduced. As a result, a natural overhead view image can be stably generated and output.

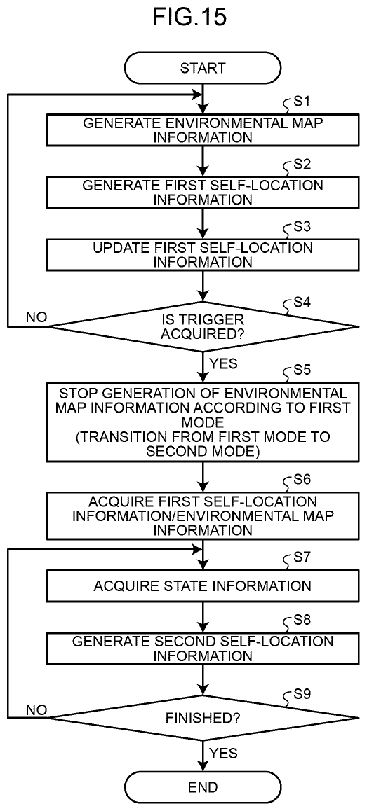

FIG. 15 is a flowchart illustrating an example of the overhead view image stabilization process according to an embodiment. Note that the overhead view image stabilization process illustrated in FIG. 15 illustrates an example of the overhead view image stabilization process performed in the state illustrated in FIG. 9.

First, the VSLAM processing unit 24 generates the environmental map information in the generation processing according to the first mode, in the section in which the mobile body 2 moves forward (Step S1).

The VSLAM processing unit 24 generates the first self-location information in the generation processing according to the first mode (Step S2). The generated first self-location information is registered in the environmental map information generated in Step S1.

The VSLAM processing unit 24 outputs the environmental map information in which the first self-location information is registered, to the second storage unit 28. The second storage unit 28 stores (updates) the environmental map information output from the VSLAM processing unit 24 (Step S3). Note that the generation of the environmental map information and the like in Steps S1 to S3 are performed with the first frequency.

The VSLAM processing unit 24 determines whether the first trigger information is acquired from the operation control unit 26 (Step S4). When the first trigger information is not acquired from the operation control unit 26 (No in Step S4), the VSLAM processing unit 24 repeatedly performs the processing of Steps S1 to S3.

Meanwhile, when the first trigger information is acquired from the operation control unit 26 (Yes in Step S4), the VSLAM processing unit 24 stops the generation of the environmental map information according to the first mode, and causes the operation to transition from the generation processing according to the first mode transfers to the generation processing according to the second mode (Step S5).

In response to the first trigger information from the operation control unit 26, the self-location updating unit 301 acquires the latest environmental map information and first self-location information from the second storage unit 28 (Step S6).

The self-location updating unit 301 acquires the state information (Step S7).

The self-location updating unit 301 performs the odometry processing by using the acquired environmental map information and state information to generate the second self-location information (Step S8).

When second trigger information is not acquired from the operation control unit 26 (No in Step S9), the self-location updating unit 301 repeatedly performs the processing of Steps S7 and S8. Meanwhile, when the self-location updating unit 301 acquires the second trigger information from the operation control unit 26 (Yes in Step S9), the self-location updating unit 301 stops the environmental map information, in the generation processing according to the second mode (Step S9).

Note that in the above overhead view image stabilization process, the example of the setting value for the second frequency set to 0 has been described. Meanwhile, for example, when the setting value for the second frequency is set to a value larger than 0 and smaller than the setting value for the first frequency, the processing of Steps S1, S2, S3, S5, and S6 is executed as periodic interruption processing according to the second frequency.

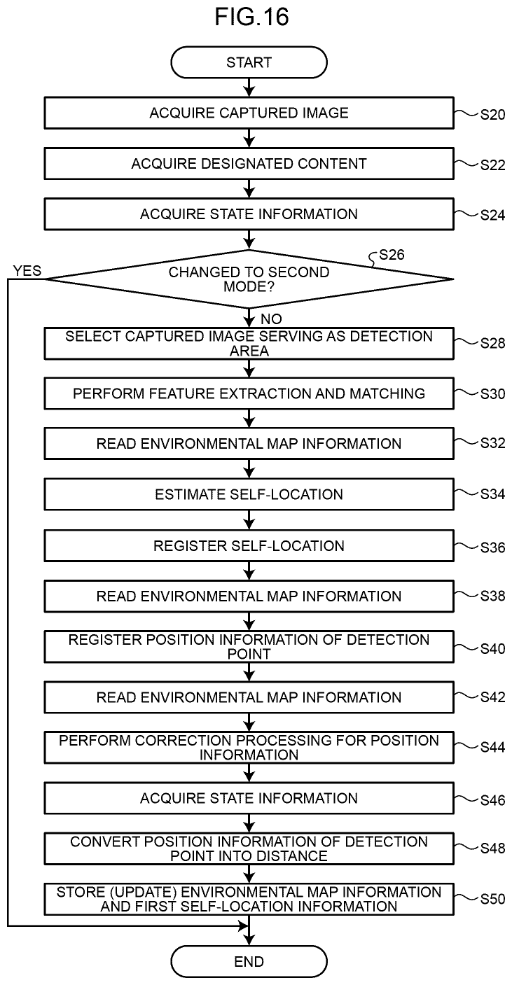

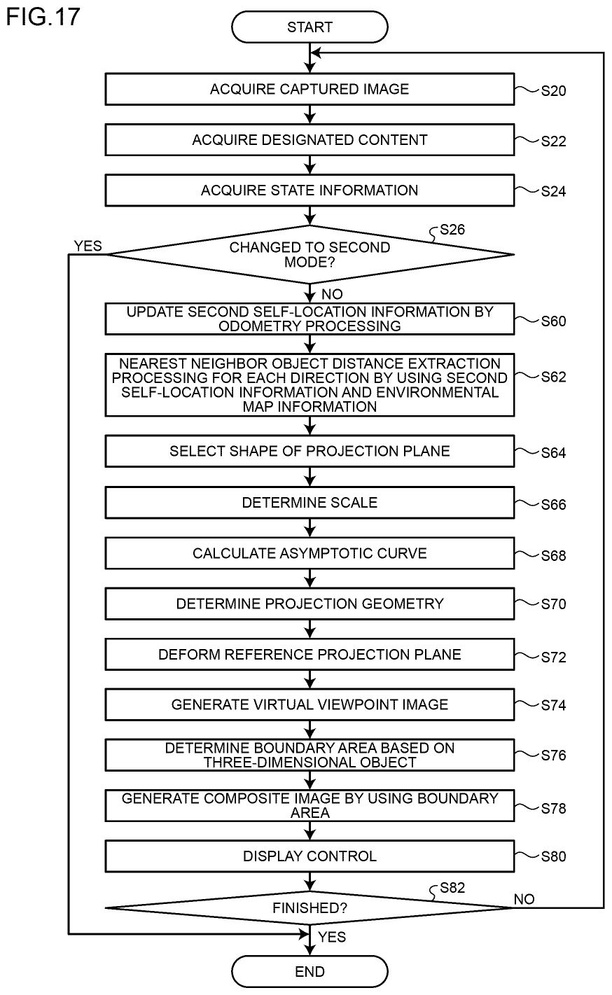

Next, an overhead view image generation process including the overhead view image stabilization process will be described with reference to FIGS. 16 and 17.

FIG. 16 is a flowchart illustrating an example of an environmental map information generation process according to the first mode before transition to the second mode.

The acquisition unit 20 acquires the captured image for each direction (Step S20).

The operation control unit 26 acquires a designated content (Step S22). Furthermore, the operation control unit 26 acquires the state information (Step S24).

The operation control unit 26 determines whether to cause the operation of the VSLAM processing unit 24 to transition from the first mode to the second mode on the basis of the acquired state information (Step S26).

When the operation control unit 26 determines the transition from the first mode to the second mode (Yes in Step S26), the operation control unit 26 generates the first trigger information and outputs the first trigger information to the VSLAM processing unit 24 and the self-location updating unit 301. The determination unit 30 of the VSLAM processing unit 24 finishes (stops) the generation processing according to the first mode, in response to the first trigger information acquired from the operation control unit 26. Thereafter, the overhead view image generation process (described later) after transition to the second mode illustrated in FIG. 17 is performed.

Meanwhile, when the operation control unit 26 determines no transition from the first mode to the second mode (No in Step S26), the operation control unit 26 does not generate the first trigger information. The VSLAM processing unit 24 does not receive the first trigger information from the operation control unit 26, and the selection unit 21 of the VSLAM processing unit 24 selects the captured image serving as the detection area (Step S28).

The matching unit 240 uses a plurality of the captured images having different image capture timings selected in Step S28 and captured by the image capture units 12 to perform the feature extraction processing and the matching processing (Step S30). In addition, the matching unit 240 registers, in the first storage unit 241, information about corresponding points between the plurality of the captured images having different image capture timings, identified by the matching processing.

The localization unit 242 reads the matching points and the environmental map information 241A (surrounding position information and self-location information) from the first storage unit 241 (Step S32).

The localization unit 242 uses a plurality of the matching points acquired from the matching unit 240 to estimate the self-location relative to the captured image by projective transformation or the like (Step S34), and registers the calculated self-location information in the environmental map information 241A (Step S36).

The three-dimensional restoration unit 243 reads the environmental map information 241A (surrounding position information and self-location information) (Step S38). The three-dimensional restoration unit 243 uses the movement amount (translation amount and rotation amount) of the self-location estimated by the localization unit 242 to perform the perspective projection transformation process, determines the three-dimensional coordinates (coordinates relative to the self-location) of the matching points, and registers the three-dimensional coordinates in the environmental map information 241A, as the surrounding position information (Step S40).

The correction unit 244 reads the environmental map information 241A (surrounding position information and self-location information) (Step S42). The correction unit 244 corrects the surrounding position information and the self-location information which have been registered in the environmental map information 241A by using, for example, the least squares method or the like so that the sum of differences in distance in the three-dimensional space is minimized with respect to a point subjected to matching a plurality of times between a plurality of frames, between three-dimensional coordinates calculated in the past and three-dimensional coordinates newly calculated (Step S44), and updates the environmental map information 241A.

The distance conversion unit 245 acquires the state information including the speed data of the mobile body 2 (speed of the mobile body 2) included in the CAN data received from the ECU 3 of the mobile body 2 (Step S46). The distance conversion unit 245 uses the speed data of the mobile body 2 to convert a coordinate distance between the point clouds included in the environmental map information 241A into, for example, an absolute distance in meters. Furthermore, the distance conversion unit 245 offsets an origin of the environmental map information to the self-location S of the mobile body 2, and generates the detection point distance information indicating a distance from the mobile body 2 to each of the plurality of detection points P (Step S48). The distance conversion unit 245 outputs the detection point distance information to the second storage unit 28 as the first self-location information.

The second storage unit 28 stores (updates) the environmental map information including the first self-location information, output from the distance conversion unit 245 (Step S50).

FIG. 17 is a flowchart illustrating an example of the overhead view image generation process after transition from the first mode to the second mode. Note that each processing of Step S20 to Step S26 is similar to that illustrated in FIG. 16, and thus the description thereof will not be repeated.

After the operation of the VSLAM processing unit 24 transitions to the generation processing according to the second mode, the self-location updating unit 301 generates the second self-location information by the odometry processing (Step S60). Furthermore, the self-location updating unit 301 outputs the environmental map information in which the generated second self-location information is registered, to the nearest neighbor identification unit 305.

The nearest neighbor identification unit 305 uses the environmental map information including the first self-location information and the second self-location information to perform nearest neighbor object distance extraction processing for each direction (Step S62). Specifically, the nearest neighbor identification unit 305 divides the surrounding of the self-location S of the mobile body 2 into specific ranges to identify the detection point P closest to the mobile body 2 or a plurality of the detection points P in order of proximity to the mobile body 2, for each range, and extracts a distance to the nearest object. The nearest neighbor identification unit 305 outputs a measured distance d of the detection point P identified for each range (a measured distance between the mobile body 2 and the nearest object) to the downstream side, as the nearest neighbor information.

The reference projection plane shape selection unit 309 selects the shape of the reference projection plane 40 on the basis of the nearest neighbor information (Step S64), and outputs the shape information about the selected shape of the reference projection plane 40 to the shape determination unit 315.

The scale determination unit 311 determines a scale of the reference projection plane 40 having the shape selected by the reference projection plane shape selection unit 309 (Step S66), and outputs scale information about the determined scale to the shape determination unit 315.

The asymptotic curve calculation unit 313 calculates the asymptotic curve on the basis of the nearest neighbor information input from the nearest neighbor identification unit 305 (Step S68), and outputs the asymptotic curve to the shape determination unit 315 and the virtual viewpoint/line-of-sight determination unit 34, as the asymptotic curve information.

The shape determination unit 315 determines how the shape of the reference projection plane is deformed as the projection geometry, on the basis of the scale information and the asymptotic curve information (Step S70). The shape determination unit 315 outputs the projection geometry information about the determined projection geometry 41 to the deforming unit 32.

The deforming unit 32 deforms the shape of the reference projection plane on the basis of the projection geometry information (Step S72). The deforming unit 32 outputs the deformed projection plane information about the deformed projection plane to the projective transformation unit 36.

The virtual viewpoint/line-of-sight determination unit 34 determines the virtual viewpoint/line-of-sight information on the basis of the self-location and the asymptotic curve information (Step S74). The virtual viewpoint/line-of-sight determination unit 34 outputs the virtual viewpoint/line-of-sight information indicating the virtual viewpoint O and the line-of-sight direction L, to the projective transformation unit 36.

The projective transformation unit 36 generates the projection image obtained by projecting the captured image acquired from each image capture unit 12 on the deformed projection plane, on the basis of the deformed projection plane information and the virtual viewpoint/line-of-sight information. The projective transformation unit 36 convers (generates) the generated projection image to a virtual viewpoint image (Step S76), and outputs the virtual viewpoint image to the image combining unit 38.

The boundary area determination unit 317 determines each of the boundary areas on the basis of the distance to the nearest object identified for each range. In other words, the boundary area determination unit 317 determines the boundary area serving as an overlapping area between the surrounding images spatially adjacent, on the basis of the position of the nearest object to the mobile body 2. The boundary area determination unit 317 outputs the determined boundary area to the image combining unit 38.

The image combining unit 38 stitches virtual viewpoint images spatially adjacent by using each boundary area to generate a composite image (Step S78). Note that, in the boundary area, the virtual viewpoint images spatially adjacent can also be blended at a predetermined ratio as well.

The display unit 16 displays the composite image serving as the overhead view image (Step S80).

The information processing device 10 determines whether to finish the information processing (Step S82). For example, the information processing device 10 determines whether a signal indicating completion of parking of the mobile body 2 is received from the ECU 3 to perform the determination in Step S82. Furthermore, for example, the information processing device 10 may perform the determination in Step S82 by determining whether an instruction for finish the information processing has been received through an operation instruction or the like from the user.

When the determination in Step S82 is negative (No in Step S82), the processing of Step S20 to Step S80 is repeatedly performed. Meanwhile, when the determination in

Step S82 is affirmative (Yes in Step S82), the overhead view image generation process including the projection geometry optimization processing according to an embodiment is finished.

The information processing device 10 according to an embodiment described above includes the VSLAM processing unit 24 serving as the map information generation unit and the self-location updating unit 301 serving as the self-location generation unit. The VSLAM processing unit 24 selectively performs the generation processing according to the first mode for generation of the map information including the position information of objects around the mobile body 2 with the first frequency and generation of first self-location information indicating the self-location of the mobile body 2, and the generation processing according to the second mode for generation of the map information with the second frequency lower than the first frequency. For example, the VSLAM processing unit 24 performs the generation processing according to the first mode while the mobile body 2 is moving forward, and performs the generation processing according to the second mode while the mobile body 2 is moving backward. In the generation processing according to the second mode, the self-location updating unit 301 uses the first self-location information and the state information of the mobile body 2 to generate the second self-location information being the position information of the mobile body 2 in the map information.

Therefore, for example, the VSLAM processing unit 24 performs the generation processing according to the first mode while the mobile body 2 is moving forward, and performs the generation processing according to the second mode while the mobile body 2 is moving backward so that the frequency of the map information generation processing requiring a high processing load can be relatively reduced during the backward movement in which the overhead view image is generated and displayed. As a result, a stable overhead view image can be generated and displayed during the backward movement.

Furthermore, the VSLAM processing unit 24 of the information processing device 10 according to an embodiment also enables to set the second frequency to 0 in the generation processing according to the second mode to stop the generation of the map information. Therefore, the information processing device 10 is allowed to considerably reduce the processing load during backward movement in which the overhead view image is generated and displayed.

Furthermore, the information processing device 10 according to an embodiment further includes the operation control unit 26 that generates the first trigger information on the basis of the state information of the mobile body 2. In response to the first trigger information, the VSLAM processing unit 24 causes the operation to transition from the generation processing according to the first mode to the generation processing according to the second mode. The self-location updating unit 301 starts generation of the second self-location information in response to the first trigger information. Furthermore, the state information of the mobile body 2 may be at least one of the information about gear change in the mobile body 2, the instruction information input from the user, and the overhead view image generation start information. Therefore, the information processing device 10 can relatively reduce the frequency of the map information generation processing requiring a high processing load at appropriate timing according to the vehicle state of the mobile body 2.

Furthermore, in the generation processing according to the second mode, the self-location updating unit 301 of the information processing device 10 according to an embodiment generates the second self-location information by using the odometry method using the state information of the mobile body, with the first self-location information as the origin. The self-location updating unit 301 uses the second self-location information and the environmental map information to calculate the distance information about a distance to an object around the mobile body 2. Therefore, the information processing device 10 is allowed to acquire the self-location information by the odometry method with a relatively light processing load without performing the VSLAM processing, and can considerably reduce the processing load.

Furthermore, the information processing device 10 according to an embodiment further includes the image generation unit 37 serving as the image combining unit that starts generation of the overhead view image showing around the mobile body in response to the first trigger information. The image generation unit 37 deforms the projection plane for the overhead view image, on the basis of the distance information. Therefore, starting the generation of the overhead view image after transition to the generation processing according to the second mode enables considerable reduction of the processing load, without simultaneously performing the generation of the overhead view image and the VSLAM processing.

The mobile body 2 moving backward for parking in a parking area sometimes stops backward movement and moves forward again after changing gears from reverse to drive, for example, when the direction of the mobile body 2 has improper direction, or when changing a planned parking position, or the like. In a second embodiment, the overhead view image stabilization process in such a case will be described.

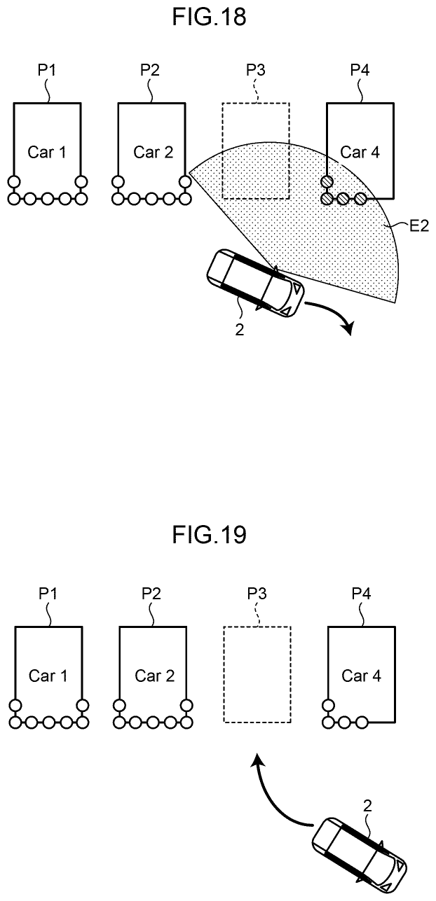

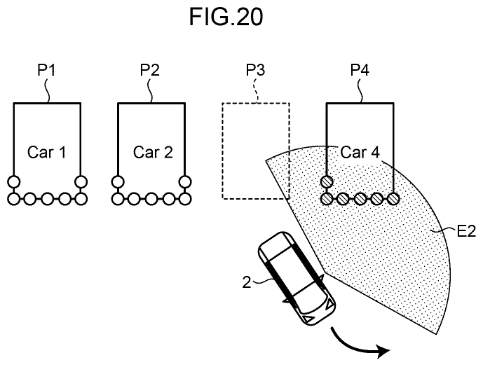

FIGS. 18, 19, and 20 are diagrams illustrating control of the frequency of an environmental map information generation process in an overhead view image stabilization process according to a second embodiment. As illustrated in FIG. 18, the mobile body 2 travels from the parking area P1 toward the parking area P4, and temporarily stops with the front side of the vehicle turned right near the parking area P4. Thereafter, gears are changed from drive to reverse in the mobile body 2, and the mobile body 2 moves backward toward the parking area P3 as illustrated in FIG. 19. However, as illustrated in FIG. 20, it is assumed that the mobile body 2 stops the backward movement, and moves forward again by changing the gears from reverse to drive for the reason of the improper direction or the like of the mobile body 2.

In such a case, during the forward movement illustrated in FIG. 18, the generation processing according to the first mode is performed, the first trigger information is output from the operation control unit 26 at the timing at which the gears are changed from drive to reverse in the mobile body 2, and the VSLAM processing unit 24 transitions the operation from the generation processing according to the first mode to the generation processing according to the second mode. Therefore, during the backward movement of the mobile body 2 as illustrated in FIG. 19, the overhead view image generation according to the overhead view image stabilization process is performed.

Furthermore, the operation control unit 26 generates the second trigger information on the basis of the state information of the mobile body 2 at the timing when the mobile body 2 stops backward movement and gears are change from reverse to drive. The operation control unit 26 outputs the generated second trigger information to the VSLAM processing unit 24 and the self-location updating unit 301. Here, the second trigger information generated by the operation control unit 26 is information for transition of the operation of the VSLAM processing unit 24 from the generation processing according to the second mode to the generation processing according to the first mode, for increasing the frequency of the generation of the environmental map information according to the state information of the mobile body 2.

Upon acquiring the second trigger information from the operation control unit 26, the VSLAM processing unit 24 causes the operation to transition from the generation processing according to the second mode to the generation processing according to the first mode. Upon acquiring the second trigger information from the operation control unit 26, the self-location updating unit 301 stops the generation of the second self-location information by the odometry processing.

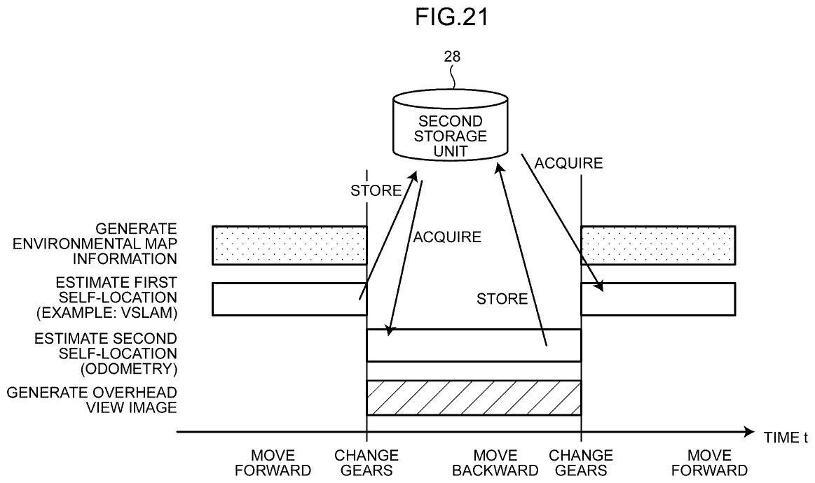

FIG. 21 is a diagram illustrating switching timing from the generation processing according to the second mode to the generation processing according to the first mode in the overhead view image stabilization process in the states illustrated in FIGS. 18, 19, and 20.

In other words, as illustrated in FIG. 21, while the mobile body 2 is moving forward, the environmental map information and the first self-location information are generated with the first frequency in the generation processing according to the first mode. At the timing when the gears are changed from drive to reverse in the mobile body 2, the generation processing according to the first mode transitions to the generation processing according to the second mode. Furthermore, at the timing when the gears are changed from reverse to drive in the mobile body 2, the generation processing according to the second mode transitions to the generation processing according to the first mode. After changing gears from reverse to drive, new environmental map information and first self-location information are generated, by the VSLAM processing using the first frequency.

Therefore, when the mobile body 2 moves forward again, the information can be further increased, by the VSLAM processing using a new first frequency, and generation of more accurate environmental map information and localization can be implemented.

Note that the VSLAM processing unit 24 may acquire the second self-location information estimated by the odometry processing of the self-location updating unit 301 to use the second self-location information as the latest self-location when the generation processing according to the first mode is resumed. In addition, matching can also be performed between the stored second self-location information and the first self-location information newly estimated in the generation processing according to the first mode.

### Modifications

In the above embodiments, the example of switching between two types of modes (the first mode and the second mode) having different generation frequencies of the environmental map information, according to the state information of the mobile body 2 has been described. Meanwhile, three or more types of modes having different generation frequencies of the environmental map information may be set and switched according to the state information of the mobile body 2. In addition, the generation frequency of the environmental map information in each mode can also be adjusted to an arbitrary value.

Note that the information processing device 10 according to the above embodiments and modifications can be applied to various apparatuses. For example, the information processing device 10 according to the above embodiments and modifications can be applied to a monitoring camera system that processes an image obtained from a monitoring camera, an in-vehicle system that processes an image of a surrounding environment outside a vehicle, and the like.

According to one aspect of the information processing device and the like disclosed in the present application, for example, when an overhead view image showing around the mobile body is generated by using generation of an environment map or estimation of the self-location, a processing load can be reduced as compared with related art.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a map information generation unit that selectively performs generation processing according to a first mode and generation processing according to a second mode, the generation processing according to a first mode generating map information including position information of an object around a mobile body with a first frequency and generating first self-location information indicating a self-location of the mobile body, the generation processing according to a second mode generating the map information with a second frequency lower than the first frequency; and
a self-location generation unit that uses the first self-location information and state information of the mobile body in the generation processing according to the second mode of the map information generation unit to generate second self-location information being position information of the mobile body in the map information.

2. The information processing device according to claim 1, wherein the map information generation unit stops generation of the map information, in the generation processing according to the second mode.

3. The information processing device according to claim 1, further comprising
an operation control unit that generates first trigger information based on the state information of the mobile body, wherein
the map information generation unit causes an operation to transition from the generation processing according to the first mode to the generation processing according to the second mode in response to the first trigger information, and
the self-location generation unit starts generation of the second self-location information in response to the first trigger information.

4. The information processing device according to claim 3, wherein
the state information of the mobile body is at least one of information about gear change in the mobile body, instruction information input from a user, and overhead view image generation start information.

5. The information processing device according to claim 1, wherein
the self-location generation unit generates the second self-location information by using an odometry method using the state information of the mobile body, with the first self-location information as an origin, in the generation processing according to the second mode.

6. The information processing device according to claim 3, wherein
the self-location generation unit uses the second self-location information and the map information to calculate distance information about a distance between the mobile body and an object around the mobile body.

7. The information processing device according to claim 6, further comprising
an image combining unit that starts generation of an overhead view image showing around the mobile body in response to the first trigger information.

8. The information processing device according to claim 7, wherein
the image combining unit deforms a projection plane for the overhead view image based on the distance information.

9. The information processing device according to claim 1, wherein
the map information generation unit performs the generation processing according to the first mode while the mobile body is moving forward, and performs the generation processing according to the second mode while the mobile body is moving backward.

10. An information processing method comprising:
selectively performing generation processing according to a first mode and generation processing according to a second mode, the generation processing according to a first mode generating map information including position information of an object around a mobile body with a first frequency and generating first self-location information indicating a self-location of the mobile body, the generation processing according to a second mode generating the map information with a second frequency lower than the first frequency; and
generating second self-location information being position information of the mobile body in the map information by using the first self-location information and state information of the mobile body in the generation processing according to the second mode.

11. A computer program product including programmed instructions embodied in and stored on a non-transitory computer readable medium, wherein the instructions, when executed by a computer, cause the computer to perform:
a map information generation function of selectively performing generation processing according to a first mode and generation processing according to a second mode, the generation processing according to a first mode generating map information including position information of an object around a mobile body with a first frequency and generating first self-location information indicating a self-location of the mobile body, the generation processing according to a second mode generating the map information with a second frequency lower than the first frequency; and
a self-location generation function of generating second self-location information being position information of the mobile body in the map information by using the first self-location information and state information of the mobile body in the generation processing according to the second mode.
